(19) United States
(12) Patent Application Publication
(10) Pub. No.: US 2010/0165505 A1
(43) Pub. Date: Jul. 1, 2010

(54) POWER SUPPLY VOLTAGE ADJUSTMENT CIRCUIT AND INFORMATION STORAGE DEVICE

(75) Inventors: Kazuhito Okita, Kunitachi-shi (JP); Yasunori Izumiya, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/643,712

(22) Filed: Dec. 21, 2009

(30) Foreign Application Priority Data
Dec. 26, 2008 (JP) 2008-332588

(51) Int. Cl. G11B 21/02

(52) U.S. Cl. 360/75

(57) ABSTRACT

According to one embodiment, a power supply voltage adjustment circuit includes a determination module and a voltage controller. The determination module determines whether a head is positioned on a data area specified by a command received from a host based on the relationship between the position of the head and the command. The head reads data from or writes data to an information recording medium. When the head is determined not to be positioned on the data area specified by the command, the voltage controller adjusts a target control value of a power supply voltage supplied to a read channel that exchanges information with the head according to a timing from a time point when a servo mark on the information recording medium is detected.

### CROSS-REFERENCE TO RELATED APPLICATIONS

This application is based upon and claims the benefit of priority from Japanese Patent Application No. 2008-332588, filed on Dec. 26, 2008, the entire contents of which are incorporated herein by reference.

### BACKGROUND

1. Field

One embodiment of the invention relates to a power supply voltage adjustment circuit and an information storage device.

2. Description of the Related Art

A magnetic recording device, for example, a hard disk drive (HDD) has been used as an external magnetic storage device for a computer, a consumer use video storage device, and the like. In recent years, users often handle information having a large volume of data (for example, moving image). Therefore, a larger capacity, higher speed, and lower cost are required of the HDD to store such information.

In the System-on-Chip (SoC) of the HDD, a read/write channel (RDC) is provided. The RDC performs a signal processing in which data to be written to a disk medium by the magnetic head is code-modulated and output to a head integrated circuit (HD IC), and the data is detected from a reproduced waveform read from the disk medium, i.e., an output signal from the HD IC, and code-demodulated.

Recently, the HDD is installed in mobile electronic devices and used in mobile environment, or externally connected to personal computers or the like through a universal serial bus (USB), etc. and used through bus power supply according to the USB standard or the IEEE 1394 standard. The HDD used in such an environment is required, especially, to consume less power.

In view of this, Japanese Patent Application Publication (KOKAI) No. 09-73704 discloses a conventional technology for power saving, in which only necessary part in the read/write circuit of a storage device is activated to reduce power consumption even during read/write operation.

With the conventional technology, power consumption can be reduced in part not necessary for read/write operation in the storage device, and power consumption can be reduced to some extent. Nevertheless, further reduction of power consumption is desired, and there is a need for a technology for further reducing power consumption.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a hard disk drive (HDD) according to an embodiment of the invention;

FIGS. 2 and 3 are exemplary flowcharts of a data write/read process to/from a magnetic disk and a power supply voltage control process in the embodiment;

FIGS. 4 and 5 are exemplary diagram for explaining the power supply voltage control in the embodiment;

FIG. 6 is an exemplary view of a voltage control table when a magnetic head is on a data area where read/write is performed in the embodiment; and

FIG. 7 is an exemplary diagram for explaining the power supply voltage control in the embodiment.

### DETAILED DESCRIPTION

Various embodiments according to the invention will be described hereinafter with reference to the accompanying drawings. In general, according to one embodiment of the invention, a power supply voltage adjustment circuit comprises a determination module and a voltage controller. The determination module is configured to determine whether a head is positioned on a data area specified by a command received from a host based on the relationship between the position of the head and the command. The head is configured to read data from or write data to an information recording medium. The voltage controller is configured to adjust, when the head is determined not to be positioned on the data area specified by the command, a target control value of a power supply voltage supplied to a read channel that exchanges information with the head according to a timing from a time point when a servo mark on the information recording medium is detected.

According to another embodiment of the invention, an information storage device comprises a head, a read channel, a power supply voltage supply module, and a power supply voltage adjustment circuit. The head is configured to read data from or write data to an information recording medium. The read channel is configured to exchange information with the head. The power supply voltage supply module is configured to supply a power supply voltage to the read channel. The power supply voltage adjustment circuit is configured to adjust a target control value of the power supply voltage. The power supply voltage adjustment circuit comprises a determination module and a voltage controller. The determination module is configured to determine whether the head is positioned on a data area specified by a command received from a host based on the relationship between the position of the head and the command. The voltage controller is configured to adjust, when the head is determined not to be positioned on the data area specified by the command, the target control value of the power supply voltage according to a timing from a time point when a servo mark on the information recording medium is detected.

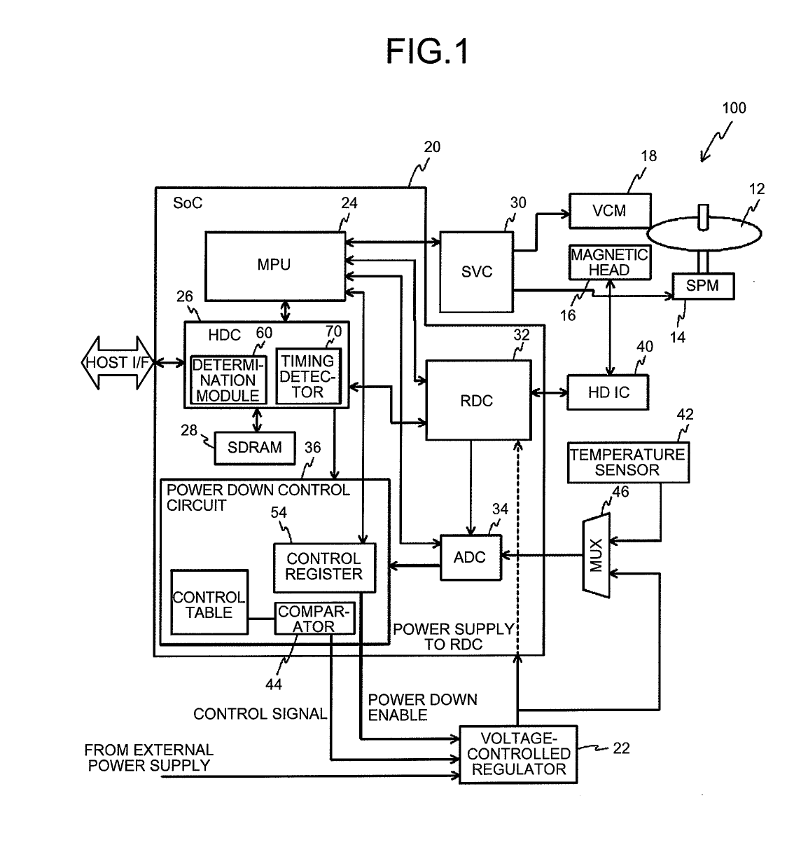

With reference to FIGS. 1 to 7, an information storage device according to an embodiment of the invention will be described.

FIG. 1 is a schematic block diagram of a hard disk drive (HDD) 100 as an example of the information storage device the of the embodiment. As illustrated in FIG. 1, the HDD 100 comprises a magnetic disk 12 as an information storage medium, a spindle motor (SPM) 14 that drives and rotates the magnetic disk 12, a magnetic head 16 that writes data to and reads data from the magnetic disk 12, a voice coil motor (VCM) 18 that moves the magnetic head 16 on the magnetic disk 12 for seek operations, a servo combo (SVC) 30, a System-on-Chip (SoC) 20 that drives and controls the SPM 14, the VCM 18, and the like, a voltage-controlled regulator 22 as a power supply voltage supply module, and a multiplexer (MUX) 46.

The SoC 20 comprises a high integration of a hard disk controller (HDC) 26, an synchronous dynamic random access memory (SDRAM) 28, a read/write channel (RDC) 32, an analog-to-digital converter (ADC) 34 as a voltage check module, a power down control circuit 36 as a voltage controller, a micro processing unit (MPU) 24, firmware that controls the operation of each module, and the like.

The HDC 26 comprises a determination module 60 that determines whether the magnetic head 16 is positioned on a read or write target data area by comparing the position of magnetic head 16 and a command content, and a timing detector 70 that detects timing of voltage control based on a value of servo frame counter. The HDC 26 also comprises an error correction circuit, a buffer control circuit, a cache control circuit, an interface control circuit (not illustrated in FIG. 1), and the like, and performs read/write control. The SDRAM 28 is a high-speed accessible memory used as a data buffer.

The RDC 32 comprises a modulation circuit for writing (recording) write data to the magnetic disk 12, a parallel/serial conversion circuit that converts write data into serial data, a demodulation circuit for reading (reproducing) data from the magnetic disk 12, and the like. The RDC 32 exchanges data (signal) with a head integrated circuit (HD IC) 40. The HD IC 40 records data on the magnetic disk 12 by switching the polarity of current supplied to the magnetic head 16 according to the write data, and outputs read data reproduced by the magnetic head 16.

The ADC 34 monitors an output value from a temperature sensor 42 and a voltage value output from the voltage-controlled regulator 22, and outputs the values to the MPU 24 and the power down control circuit 36.

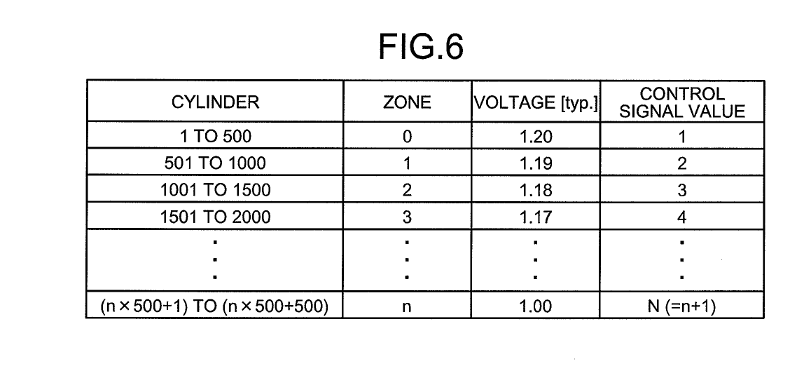

The power down control circuit 36 supplies a power down enable signal and a control signal to the voltage-controlled regulator 22. The power down control circuit 36 comprises a control register 54, a control table, and a comparator 44. The control register 54 calculates a count value of the servo frame counter used for power down control. The control table indicates a relationship between a target zone from/to which information is read/written and a control signal of voltage value supplied to the RDC 32 (see FIG. 6). The comparator 44 supplies the control signal to the voltage-controlled regulator 22 based on the control table.

The MPU 24 controls the overall operation of the HDD 100, including a head positioning control, interface control, initialization and setting of each peripheral LSI, and defect management.

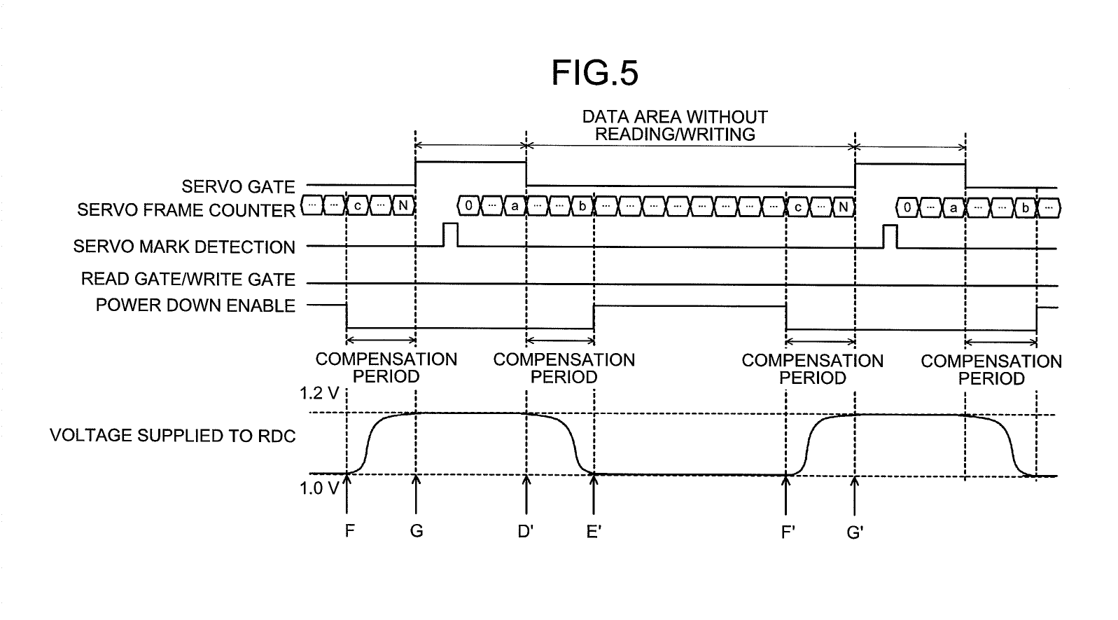

The voltage-controlled regulator 22 supplies a power supply voltage supplied from an external power supply to modules in the SoC 20 and modules outside the SoC 20. The voltage-controlled regulator 22 is configured to be able to change at least the voltage value supplied to the RDC 32. For example, the voltage-controlled regulator 22 changes the voltage value based on a control signal value output from the power down control circuit 36, and supplies the voltage to the RDC 32. The voltage-controlled regulator 22 also changes the voltage value depending on whether the power down enable signal output from the power down control circuit 36 is asserted or negated, and supplies the power supply voltage to the RDC 32. In the embodiment, for example, as illustrated in FIG. 5 and the like, when the power down enable signal is asserted, a power supply voltage of 1.2 V is supplied to the RDC 32, and when the power down enable signal is negated, a power supply voltage of 1.0 V is supplied to the RDC 32.

The SVC 30 drives and controls the SPM 14 and the VCM 18, and performs servo (positioning) control of the magnetic head 16 on the magnetic disk 12.

The multiplexer 46 selectively outputs either the output from the temperature sensor 42 or the voltage value output from the voltage-controlled regulator 22 to the ADC 34.

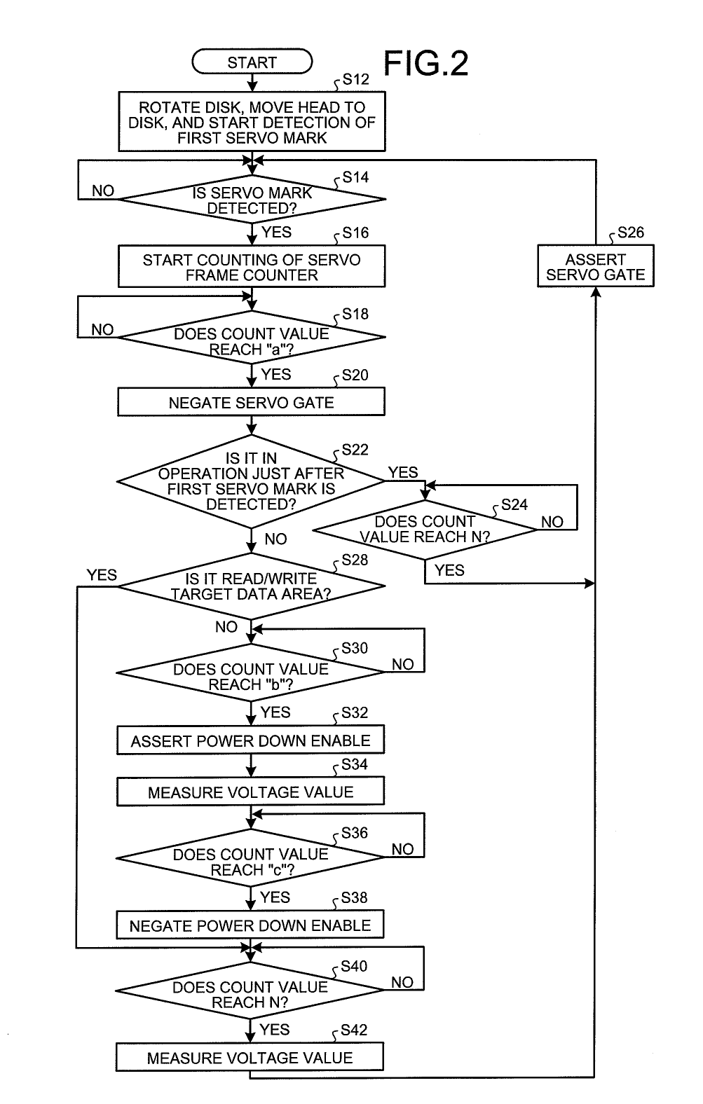

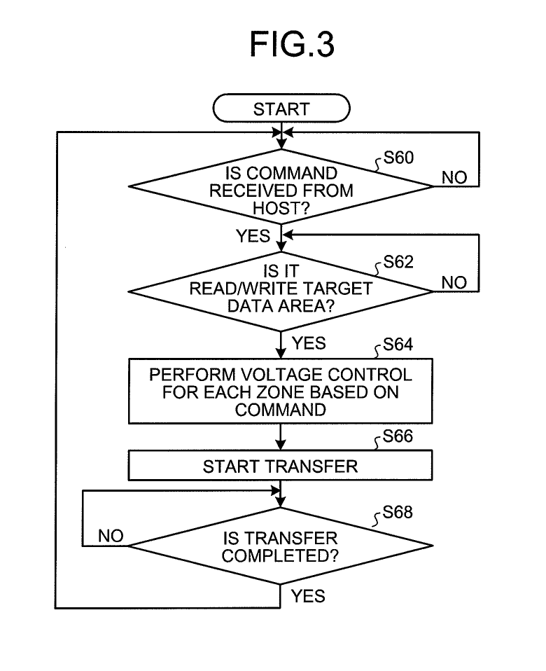

Next, a data write process to the magnetic disk 12, a data read process from the magnetic disk 12, and a power supply voltage control process using the HDD 100 configured as above will be described with reference to FIGS. 2 and 3.

In the example of FIG. 2, the initial setting of the power supply voltage control is assumed to be completed. The initial setting includes setting of the control register 54 of the power down control circuit 36, and setting of the voltage value when the power down enable signal is asserted (here, 1.2 V) and the voltage value when the power down enable signal is negated (here, 1.0 V). The initial setting further includes setting in which the power down control circuit 36 creates the control table (see FIG. 6) indicating a relationship between cylinder, zone, voltage value, and control signal value based on zone information loaded in advance into an internal memory of the SoC 20 as parameters.

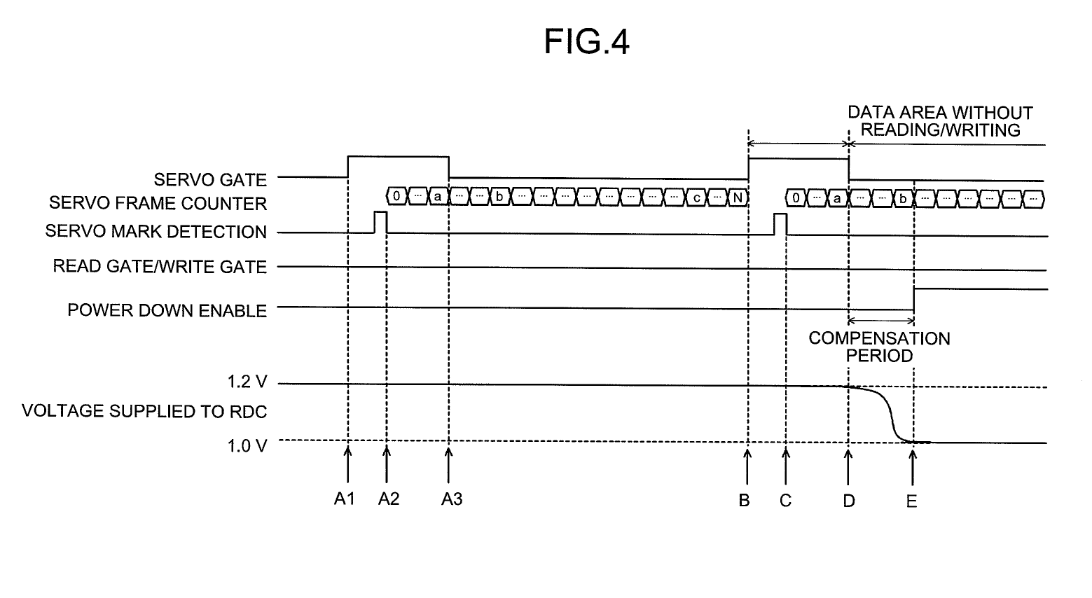

First, when the HDD 100 is turned on, the MPU 24 rotates the magnetic disk 12, moves the magnetic head 16 onto the magnetic disk 12, and starts detection of the first servo mark (S12). To detect the first servo mark, the MPU 24 (firmware) asserts the servo gate as indicated by a time point A1 in FIG. 4. The MPU 24 rotates the magnetic disk 12 by drive control of the SPM 14 via the SVC 30, and the MPU 24 moves the magnetic head 16 by drive control of the VCM 18 via the SVC 30.

The HDC 26 (the timing detector 70) waits until the servo mark is detected by the magnetic head 16 (S14). When the servo mark is detected (at the time point A2 when the servo mark detection signal is output indicated in FIG. 4), the HDC 26 (the timing detector 70) starts counting of the servo frame counter (S16).

Next, the HDC 26 (the timing detector 70) determines whether the count value reaches “a” (S18). The value “a” is a value determined in advance according to a radial position (zone), at which the magnetic head 16 is positioned, on the magnetic disk 12. When the count value reaches “a” (YES at S18), the HDC 26 negates the servo gate (refer to the time point A3 in FIG. 4) (S20).

The HDC 26 determines whether it is in operation just after the first servo mark is detected (S22). If it is in operation (YES at S22), the process moves to S24.

The HDC 26 (the timing detector 70) waits until the count value of the servo frame counter reaches N (S24). The value N is a value determined in advance according to a radial position (for example, zone), at which the magnetic head 16 is positioned, on the disk. If the count value of the servo frame counter reaches N (YES at S24), the HDC 26 asserts the servo gate (refer to the time point B in FIG. 4) (S26), and the process returns to S14.

When the servo mark is detected (YES at S14), counting of the servo frame counter is started (refer to the time point C in FIG. 4) (S16). The HDC 26 (the timing detector 70) determines whether the count value reaches “a” (S18). When the count value reaches “a” (YES at S18), the HDC 26 negates the servo gate (refer to the time point D in FIG. 4) (S20). Next the HDC 26 determines whether it is in operation just after the first servo mark is detected (S22), and if not (NO at S22), the process moves to S28. When the determination result of S22 is NO, the process of FIG. 3 starts in parallel with the process of FIG. 2.

In FIG. 3, first, the HDC 26 waits until a command (here, a command to write data to the magnetic disk 12) is received from a host (S60). After a command is received from the host (YES at S60), the HDC 26 waits until the magnetic head 16 reaches a read or write target data area (S62).

On the other hand, in FIG. 2, the HDC 26 (determination module 60) determines whether the magnetic head 16 reaches the read or write target data area based on a comparison between information detected from the servo mark and the command from the host (S28). If not (NO at S28), the process moves to S30. When the command from the host is not received, the determination result is NO, and the process moves to S30.

The HDC 26 (the timing detector 70) determines whether the count value of the servo frame counter reaches “b” (S30). The value “b” is obtained by adding a predetermined value “k” (for example, k=3) to the value “a”. The value “b” (=a+k) is calculated by the control register 54. When the count value of the servo frame counter reaches “b” (YES at S30), the process moves to S32, and the power down control circuit 36 asserts the power down enable (refer to the time point E in FIG. 4). In this way, in the embodiment, since the power supply voltage is not lowered while the servo gate is asserted (between the time points B and D), influence on the read operation of servo information can be avoided.

Next, the ADC 34 measures the value of power supply voltage supplied to the RDC 32 (S34). The measurement result is fed to the power down control circuit 36.

The HDC 26 (the timing detector 70) waits until the count value reaches “c” (S36). The value “c” is obtained by subtracting a predetermined value “k” from the value N. The value “c” (=N−k) is calculated by the control register 54.

Next, the power down control circuit 36 negates the power down enable (refer to the time point F in FIG. 5) (S38).

Next, the HDC 26 (the timing detector 70) waits until the count value reaches N (S40). In the embodiment, as described above, since the voltage supplied to the RDC 32 is raised from the time (the time point F) before the servo gate is asserted, the power supply voltage rises to 1.2 V in a period (compensation period) in which the count value illustrated in FIG. 5 is changed from “c” to N.

Thereafter, when the count value reaches N (YES at S40), the process moves to S42, and the ADC 34 measures the value of power supply voltage supplied to the RDC 32. The measurement result is fed to the power down control circuit 36.

As a result of the measurement at S34 and S42, when the voltage value is substantially different from the desired value (1.0 V at S34, 1.2 V at S40), for example, the HDC 26 outputs an error. However, it is not so limited, and when the voltage value is substantially different from the desired value, the value “k” used by the register may be corrected (by feedback control).

Thereafter, the HDC 26 asserts the servo gate (S26), and the process returns to S14. When the next data area is also a data area where reading or writing is not performed (here, writing is not performed), by performing the process from S14 to S42 in the sequence described above, the power supply voltage is controlled as indicated by the time points D′→E′→F′→G′ in FIG. 5. In this case also, since the power supply voltage is lowered and raised between the time points D′ and E′, and the time points F′ and G′ (in the compensation period), the power supply voltage is maintained at 1.2 V while the servo gate is asserted.

On the other hand, after the process from S14 through S16, S18, and S20 to S22, if the magnetic head 16 reaches the read or write target data area (YES at S28), the process directly moves to S40. In this case, since the determination result of S62 in FIG. 3 is also YES, the firmware in the power down control circuit 36 performs voltage control according to zone as described below (S64).

The power down control circuit 36 (the comparator 44) determines a voltage value from the zone number specified by a command input from the host based on the table illustrated in FIG. 6, and generates a control signal value. For example, when the zone number specified by the command received from the host is “2”, the voltage is determined to be “1.18 V” and the control signal value “3” is generated.

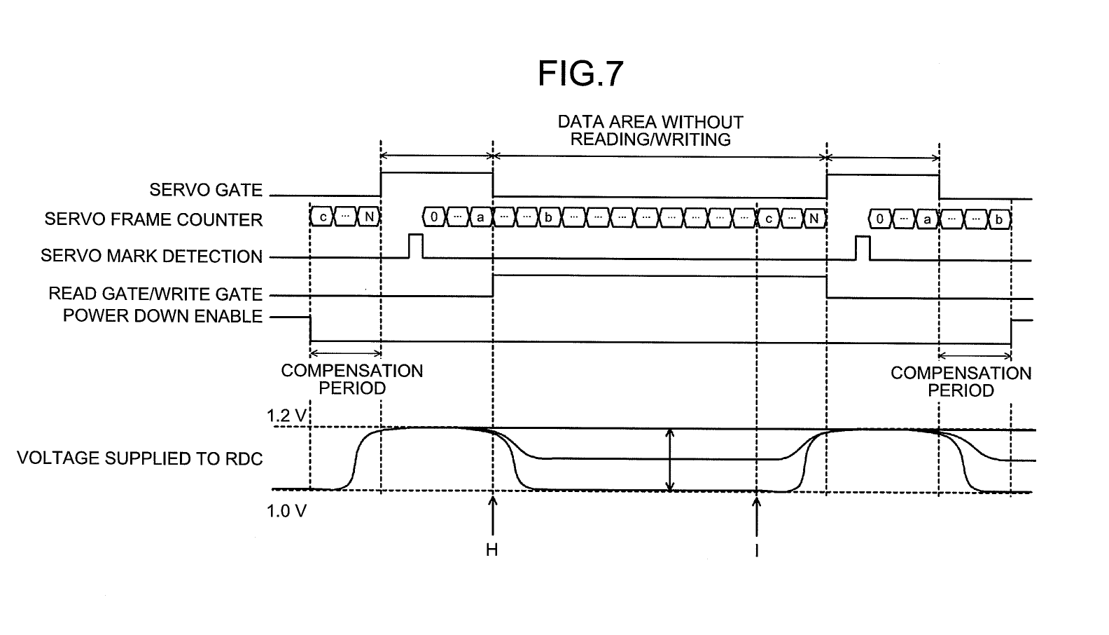

Thereafter, the power down control circuit 36 (the comparator 44) supplies the control signal value to the voltage-controlled regulator 22. The voltage-controlled regulator 22 performs the power supply voltage control in a period between the time point H (time point when the count value of the servo frame counter is “a”) and the time point I (time point when the count value of the servo frame counter is “c”) in FIG. 7 based on the control signal value, and supplies the power supply voltage after the control to the RDC 32.

After the supply of the power supply voltage to the RDC 32 starts as described above, the MPU 24 may check whether a correct power supply voltage (set voltage) is supplied from the voltage-controlled regulator 22. In this case, whether a correct power supply voltage is supplied can be checked based on, for example, whether the control signal value input to the voltage-controlled regulator 22 matches the value set in the power down control circuit 36. It can also be checked based on whether the output value (voltage value) of the voltage-controlled regulator 22 obtained via the multiplexer 46 and the ADC 34 is the set voltage value. As a result of the check, if the voltage is not the set voltage, the control signal value may be supplied again to the voltage-controlled regulator 22.

While the above power supply voltage control is performed, signal processing is performed on write data in the RDC 32, and the signal of the write data is transferred to the HD IC 40 (S66). The HD IC 40 writes the transferred signal to a specified zone (cylinder) with the magnetic head 16.

Next, it is waited that the data transfer is completed (S68), and the process returns to S60 when the data transfer is completed.

On the other hand, at S40 in FIG. 2, the HDC 26 (the timing detector 70) waits until the count value reaches N. After the count value reaches N, at S42, the ADC 34 measures the value of power supply voltage supplied to the RDC 32, and the HDC 26 asserts the servo gate (S26). Thereafter, the process returns to S14.

Although the direction of data flow is different, the process of reading data from the magnetic disk 12 is performed basically in a similar manner as the process of writing data to the magnetic disk 12 described above.

As described above, according to the embodiment, when the HDC 26 (the timing detector 60) determines that the magnetic head 16 is not positioned on a read or write target area on the magnetic disk 12, the power down control circuit 36 adjusts voltage supplied to the RDC 32 via the voltage-controlled regulator 22 according to the timing from a time point when the servo mark is detected (adjusts a target control value of the voltage-controlled regulator 22 by using the power down enable signal). Thus, it is possible to lower the voltage when the function of the RDC 32 is not required (when reading or writing of information and reading of a servo mark are not performed). Therefore, the power consumption can be reduced without affecting reading or writing (reading or writing of data, reading of servo information, and the like) by the magnetic head 16.

The HDD 100 of the embodiment in which lower power consumption is realized can be preferably to the case where voltage supplied from external power supply is small, such as where the HDD is installed in a mobile electronic device, or is externally connected to a personal computer or the like and power is supplied through a bus according to the USB standard or the IEEE 1394 standard.

According to the embodiment, the HDC 26 (the timing detector 70) detects the timing to lower the power supply voltage supplied to the RDC 32 based on the value of the servo frame counter counted from when the servo mark is detected. Thus, it is possible to determine the timing to lower the voltage by a simple method.

Moreover, the voltage is raised/lowered in the compensation period before/after the servo gate is asserted. Accordingly, voltage necessary to detect the servo mark can always be supplied when the servo gate is asserted. Thus, the servo information can be read with a high degree of accuracy.

Furthermore, whether voltage necessary to detect the servo mark is supplied is checked while the servo gate is asserted. Thus, it is possible to reduce the influence on reading/writing of data by changing the length of the compensation period or outputting an error based on the check result as well as to realize lower power consumption.

Still further, a power supply voltage corresponding to the transfer rate of the magnetic head 16 can be supplied even when the magnetic head 16 is positioned on the read or write target area. Thus, it is possible to reduce the power consumption while data is being read or written. In this case, since the power supply voltage is independently supplied to the RDC 32 and other internal blocks (internal constituent elements) in the SoC 20 from the voltage-controlled regulator 22, changing the power supply voltage to the RDC 32 does not affect the other blocks in the SoC 20 and the external blocks (the HD IC 40, the magnetic head 16, the VCM 18, the SPM 14, and the like).

According to the embodiment, since the power down control circuit 36 determines the voltage value supplied to the RDC 32 based on the zone where the HD IC 40 reads data from or writes data to the magnetic disk 12 and the control table indicating the relationship between zones on the magnetic disk 12 and voltage values corresponding to the transfer rates of the respective zones, it is possible to simply determine an appropriate voltage value.

In the embodiment, power supply voltage control may be performed correspondingly to the measurement result of the temperature sensor 42 illustrated in FIG. 1. For example, since it is expected that the lower the temperature, the higher the efficiency of the operation of semiconductor constituting the SoC 20, when the magnetic head 16 is positioned on a data area which is not the read or write target data area and the temperature is lower than normal temperature, the voltages illustrated in FIGS. 4, 5, and 7 (1.2 V in normal time, 1.0 V when voltage is lowered) may be set lower than the values (for example, 1.1 V in normal time, 0.9 V when voltage is lowered). On the contrary, when the temperature is relatively high, the voltages illustrated in FIG. 4, etc. may be set higher (for example, 1.3 V in normal time, 1.0 V when voltage is lowered). In this way, it is possible to perform voltage control with a high degree of accuracy considering the features of the RDC 32 which vary depending on temperature.

When the magnetic head 16 is positioned on the read or write target data area, power supply voltage control may also be performed correspondingly to the measurement result of the temperature sensor 42 illustrated in FIG. 1. In this case, for example, by preparing a plurality of tables such as illustrated in FIG. 6 corresponding to temperatures, the tables may be selectively used according to the measurement result of the temperature sensor 42. For example, when the temperature is normal, the table in FIG. 6 (upper limit is 1.2 V and lower limit is 1.0 V) may be used. When the temperature is low, a table in which the upper limit and the lower limit of the table in FIG. 6 are lowered (for example, a table in which the upper limit is 1.1 V and the lower limit is 0.9 V) may be used. When the temperature is high, a table in which the upper limit and the lower limit of the table in FIG. 6 are raised (for example, a table in which the upper limit is 1.3 V and the lower limit is 1.1 V) may be used. In this case also, it is possible to perform voltage control with a high degree of accuracy considering the features of the RDC 32 which vary depending on temperature.

In the embodiment, although the process of FIG. 2 is described as being always performed, it is not so limited. For example, the HDD 100 may be configured to be set to “normal mode” or “power save mode” by the user through a switch provided to the HDD 100, and only in the “power save mode”, the process of FIG. 2 may be performed. The modes need not necessarily be switched by the user, and the modes may be switched according to the use condition of the HDD 100, such as, for example, the “normal mode” is selected when the HDD 100 is connected to an external power supply via an AC adaptor, and the “power save mode” is selected when the HDD 100 is connected to an external power supply via a USB cable.

In the embodiment, although an example in which the voltage is changed for each zone as illustrated in FIG. 6 is described, it is not so limited. For example, the voltage may be changed for each group of zones when fine voltage control cannot be performed due to the performance of the voltage-controlled regulator 22.

In the embodiment, although the voltage value is checked after the compensation period has elapsed, it is not so limited. The voltage value need not necessarily be checked.

In the embodiment, although an example in which the timing detector 70 counts up the servo frame counter from 0 to N is described, it is not so limited. For example, the timing detector 70 may count down the servo frame counter from N to 0.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power voltage adjustment device comprising:
a determination module configured to determine whether ahead is positioned on a data area addressed by a command received from a host based on a relationship between a position of the head and the command, the head is configured to read data from an information recording medium and to write data to the information recording medium; and
a voltage controller configured to adjust a target control value of a power voltage supplied to a read channel configured to exchange information with the head according to a duration from when a servo mark on the information recording medium is detected, when the head is determined not to be positioned on the data area addressed by the command.

2. The power voltage adjustment device of claim 1, further comprising a duration detector configured to detect the duration from when the servo mark is detected based on a value of a servo frame counter counted from the time point when the servo mark is detected.

3. The power voltage adjustment device of claim 1, wherein the voltage controller is configured to determine the duration in such a manner that the power voltage corresponds to a voltage used to detect the servo mark while a servo gate indicative of a time of detection of the servo mark is being asserted.

4. The power voltage adjustment device of claim 1, further comprising a voltage check module configured to check the power voltage while the servo gate is being asserted.

5. The power voltage adjustment device of claim 1, wherein the voltage controller is configured to change the target control value of the power voltage according to a temperature of the read channel.

6. The power voltage adjustment device of claim 1, wherein the voltage controller is configured to adjust the target control value of the power voltage corresponding to a transfer rate of the head when the head is determined to be positioned on the data area addressed by the command.

7. The power voltage adjustment device of claim 6, wherein the voltage controller is configured to adjust the target control value of the power voltage according to a zone on the information recording medium from which the head is configured to read data or to which the head is configured to write data.

8. An information storage device comprising:
a head configured to read data from an information recording medium or to write data to the information recording medium;
a read channel configured to exchange information with the head;
a power supply module configured to supply a voltage to the read channel; and
a power voltage adjustment circuit configured to adjust a target control value of the supply voltage, the power voltage adjustment circuit comprising
a determination module configured to determine whether the head is positioned on a data area addressed by a command received from a host based on a relationship between a position of the head and the command; and
a voltage controller configured to adjust the target control value of the power voltage according to a duration from a time point when a servo mark on the information recording medium is detected, when the head is determined not to be positioned on the data area addressed by the command.
